(19) United States
(12) Patent Application Publication
(10) Pub. No.: US 2026/0175381 A1
(43) Pub. Date: Jun. 25, 2026

(54) ATTACHMENT FOR A ROTARY POWER TOOL AND COMBINATION OF A ROTARY POWER TOOL AND AN ATTACHMENT

(71) Applicant: Robert Bosch GmbH, Stuttgart (DE)

(72) Inventors: Jeremy Rubens, Palatine, IL (US); Alexander Hills, Belvedere, IL (US)

(21) Appl. No.: 19/415,090

(22) Filed: Dec. 10, 2025

Related U.S. Application Data
(60) Provisional application No. 63/738,118, filed on Dec. 23, 2024.

(51) Int. Cl. B25B 23/18; B25F 5/02

(52) U.S. Cl. CPC B25B 23/18; B25F 5/029

(57) ABSTRACT

An attachment for a rotary power tool and a combination of an attachment and a rotary power tool. The rotary power tool has an attachment coupler and a light source which are disposed at a front end of the rotary power tool. The attachment comprises: a coupling portion configured to be mechanically coupled to the attachment coupler, a proximal end configured to abut the front end, a distal end, and a middle portion disposed between the proximal end and the distal end. The attachment further comprises an optical fiber cable that includes: a light exit section configured to emit light, a light entrance section configured to be optically coupled to the light source, and an intermediate section connecting the light exit section and the light entrance section and configured to guide light from the light source to the light exit section.

### TECHNICAL FIELD

The present disclosure relates to power tools, such as rotary power tools, particularly to an attachment for a rotary power tool.

### BACKGROUND

Power tools, such as rotary power tools are a favorite instrument of professional craftsmen, handymen, homeowners, and hobbyists. The typical rotary power tool is a handheld power tool configured for use with a variety of accessory bits/tools that can be used for cutting, carving, sanding, polishing, and many other applications, referred to collectively as cutting operations. One specific example of a rotary power tool is the DREMEL® rotary power tool sold by the Robert Bosch Tool Corporation.

Some rotary power tools have an attachment coupler disposed at a front end of the rotary power tool. Various attachments for rotary power tools are available. Some attachments comprise a coupling portion configured to be mechanically coupled to the attachment coupler, a proximal end configured to abut the front end, a distal end, and a middle portion disposed between the proximal end and the distal end. Examples of attachments are saw attachments, cutting attachments, right angle attachments, rotary shield attachments, sharpening kits, sanding/grinding guides, dust blowers, grout removal attachments, flex shaft attachments, detailing attachments, and nose caps with or without lights etc.

If the workpiece or an area needs to be illuminated, some rotary power tools have a light source disposed at a side or the front end. Some attachments have a light source at the distal end. These latter attachments may be powered by an electric cable running from the rotary power tool to the distal end. It is also known to affix a dynamo that provides electrical power to a light.

It may be desirable to illuminate a workpiece or an area without having to provide electrical power to the distal end which may eliminate or reduce the need for electrical insulation. It may also be desirable to reduce the complexity and space required for a dynamo.

### SUMMARY

One aspect of this disclosure is directed to an attachment for a rotary power tool, the rotary power tool having an attachment coupler and a light source which are disposed at a front end of the rotary power tool, the attachment comprising: a coupling portion configured to be mechanically coupled to the attachment coupler, a proximal end configured to abut the front end, a distal end, and a middle portion disposed between the proximal end and the distal end, wherein the attachment further comprises an optical waveguide that includes: a light entrance section disposed at the proximal end and configured to be optically coupled to the light source, a light exit section disposed at the distal end, and an intermediate section connecting the light exit section and the light entrance section and configured to guide light from the light source to the light exit section.

In another aspect, the coupling portion is configured to accommodate a shaft of the rotary power tool.

In another aspect, the shaft protrudes from the coupling portion.

In another aspect, the intermediate section forms a nonlinear path.

In another aspect, the distal end comprises a holder for an accessory which is configured to perform an operation on a workpiece and the light exit section is arranged to emit light onto the workpiece.

In another aspect, the distal end is configured to perform an operation on a workpiece and the light exit section is arranged to emit light onto the workpiece.

In another aspect, the attachment comprises a flexible power transmission shaft extending from the coupling portion to the distal end and the waveguide is arranged along the flexible power transmission shaft.

In another aspect, the coupling portion has an internal thread configured to be fastened to an external thread of the attachment coupler, wherein the internal thread and the external thread, when the coupling portion is mechanically coupled to the attachment coupler, define a central axis, and the internal thread and the external thread are angularly aligned so that the light entrance section is optically coupled to the light source.

In another aspect, the light entrance section and the light source are generally aligned in a direction that is parallel to the central axis.

In another aspect, the attachment is a nose cap.

In another aspect, the coupling portion is removably coupled to the attachment coupler.

Another aspect of the disclosure is directed to a combination of a rotary power tool and an attachment comprising: the rotary power tool having an attachment coupler and a light source which are disposed at a front end of the rotary power tool, the attachment comprising: a coupling portion mechanically coupled to the attachment coupler, a proximal end abutting the front end, a distal end, and a middle portion disposed between the proximal end and the distal end, wherein the attachment further comprises an optical waveguide that includes: a light entrance section is disposed at the proximal end and optically coupled to the light source, a light exit section disposed at the distal end, and an intermediate section connecting the light entrance section and the light exit section that guides light from the light source to the light exit section.

The above aspects of this disclosure and other aspects will be explained in greater detail below with reference to the attached drawings.

### BRIEF DESCRIPTION OF THE DRAWINGS

FIG. 1 shows an exploded view of a rotary power tool and a nose cap;

FIG. 2 shows the nose cap of FIG. 1 from a different view;

FIG. 3 shows a part of the rotary power tool and the nose cap assembled;

FIG. 4 shows the rotary power tool with a flex shaft attachment;

FIG. 5 shows a ring attachment with an optical fiber cable;

FIG. 6 shows a second nose cap; and

FIG. 7 the rotary power tool with a detailing attachment.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

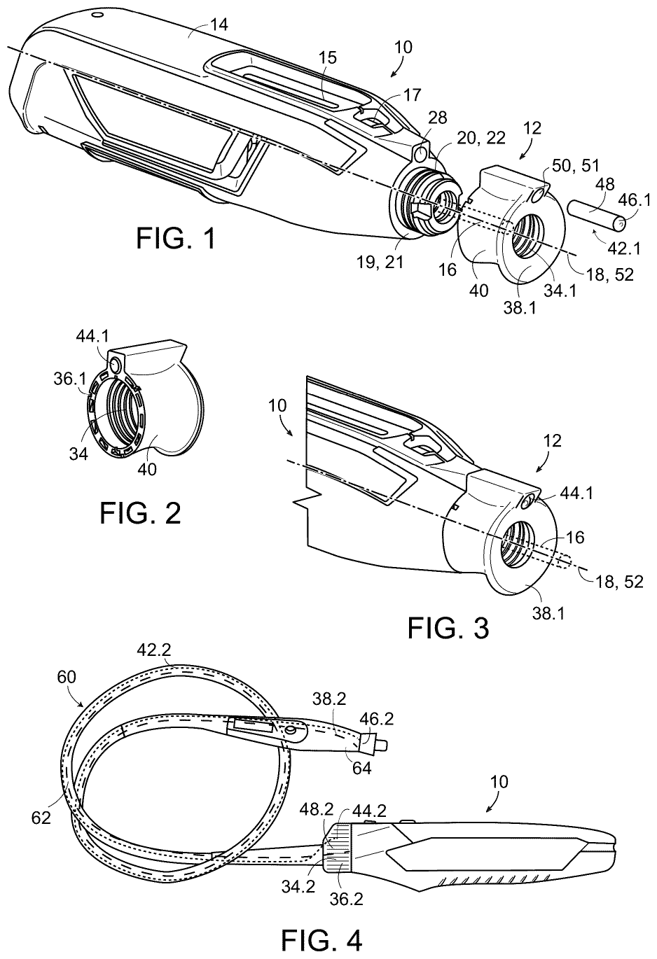

FIGS. 1, 2 and 3, show a rotary power tool 10 and a nose cap 12 as an attachment. The rotary power tool 10 comprises an elongated housing 14 configured to be handheld. A sliding switch 15 is disposed on the housing 14 to turn the rotary power tool 10 on and off but may also be configured to change the rotary speed as shown in the example. The rotary power tool 10 also comprises a shaft 16 (hinted at in dashed lines) and a shaft lock button 17. The shaft 16 defines an axis 18. At a front end 19 from which the shaft 16 protrudes, the rotary power tool 10 has a nose piece 20 as an attachment coupler. The nose piece 20 extends along the axis 18. In the example shown, the front end 19 has a shoulder 21 or flange and the nose piece 20 protrudes from the front end 19 and abuts the shoulder 21. When the nose piece 20 is coupled to, or mounted on, the rotary power tool 10, the shaft 16 protrudes from the nose piece 20. The nose piece 20 has an external thread 22. As an alternate attachment coupler an internal thread could extend into the front end 19. The rotary power tool 10 has an LED 28 as a light source. As an alternate light source an incandescent or compact fluorescent light source may be chosen. In addition to the nose piece 20, the LED 28 is also disposed at the front end 19 of the rotary power tool 10. In the example shown the LED 28 is radially offset from the shoulder 21 but may also be disposed within the shoulder 21.

The nose cap 12 generally has the shape of a tube or a hollow cylinder and comprises an internal thread 34.1 as a coupling portion that is configured to be mechanically coupled to the nose piece 20. The nose cap 12 is configured to accommodate the shaft 16 of the rotary power tool 10 when the nose cap 12 is attached to the nose piece 20 and therefore to the rotary power tool 10. The shaft 16 may protrude from the internal thread 34.1 and therefore from the nose cap 12. The external thread 22 and the internal thread 34.1 allow the nose cap 12 to be removably coupled to the nose piece 20 so that different attachments can be used. FIG. 3 shows the nose cap 12 fastened to the external thread 22 of the nose piece 20 and the shaft 16 protruding from the nose cap 12. The nose cap 12 also comprises a proximal end 36.1 in a ring shape that is disposed on one end of the nose cap 12 and is configured to abut, and in FIG. 3 does abut, the front end 18. A distal end 38.1 is disposed on the other side of the nose cap 12 and facing away from the proximal end 36.1. A middle portion 40 is disposed between the proximal end 36.1 and the distal end 38.1.

The nose cap 12 further comprises an optical fiber cable 42.1 as an optical waveguide. The optical fiber cable 42.1 may be e.g. a single cable, a bundle of cables, or a light pipe, and may be stiff or flexible; it may also be made of glass fiber or plastic fiber. Optical fiber cables 42.1 are generally less expensive than electrical cables. The optical fiber cable 42.1 comprises a light entrance section 44.1 disposed on the proximal end 36.1 and is configured to be optically, and in FIG. 3 is, coupled to the LED 28. The optical fiber cable 42.1 also includes a light exit section 46.1 disposed at the distal end 38.1 and configured to illuminate an area in front of the distal end 38.1. This may be the area alone and/or a workpiece. There may be an additional lens arranged in front of the light exit section 46.1. The optical fiber cable 42.1 further includes an intermediate section 48 connecting the light entrance section 44.1 and the light exit section 46.1 and is configured to guide light from the LED 28 to the light exit section 46.1. The optical fiber cable 42.1 is arranged in a channel 50 of the nose cap 12. The channel 50 may be defined by a cylindrical surface 51. The channel 50 extends from the proximal end 36.1 to the distal end 38.1 of the nose cap 12. When the external thread 22 as the coupling portion is fastened, and therefore mechanically coupled, to the internal thread 34 as the attachment coupler, the internal thread 34 and the external thread 36.1, define a central axis 52. The central axis 52 is aligned with the axis 18. The channel 50 and the LED 28 are arranged at the same radial distance from the central axis 52. The internal thread 34 and the external thread 22 are angularly aligned which enables the light entrance section 44.1 being optically coupled to the LED 28. In the example shown, the light entrance section 46.1 and the LED 28 are generally aligned in a direction that is parallel to the central axis 52.

FIG. 4 shows the rotary power tool 10 with a flex shaft attachment 60 which is flexible. The flex shaft attachment 60 comprises a flexible power transmission shaft 62 (hinted at with a dashed line) extending from an internal thread 34.2 at a proximal end 36.2 as a coupling portion to a distal end 38.1. A fiber optic cable 42.2 (hinted at with a dotted line) is arranged along the length of the flexible power transmission 62 of the shaft attachment 60. The distal 38.1 end comprises a holder 64 for an accessory which is configured to perform an operation on a workpiece. As an alternative the distal end 38.1 itself may be configured to perform an operation on a workpiece. In both cases, a light exit section 46.2 is arranged to emit light onto the workpiece or an area around a workpiece. A light exit section 46.2 can emit light onto the workpiece. An intermediate section 48.2 near the light entering section 44.2 has a step and forms a nonlinear path.

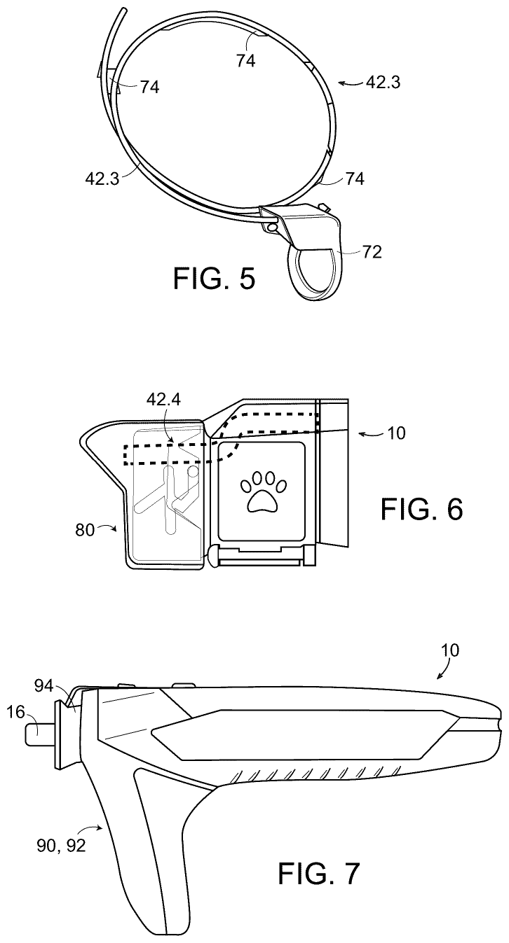

FIG. 5 shows an elongated illuminating attachment 70. The elongated illuminating attachment 70 has a ring 72 that can be attached to the nose piece 20 of the rotary power tool 10 and secured e.g. with a nut. Attachment means 74 are disposed along a fiber optic cable 42.3. The attachment means 74 may be adhesive strips, clips, magnets, brackets, loops etc. These allow the elongated illuminating attachment 70 to be affixed e.g. to a flex shaft attachment that does not have a light at the distal end.

FIG. 6 shows the front of the rotary power tool 10 with a ring-shaped illuminating attachment 80 similar to the nose cap 12. Illustrated with dashed lines is an intermediate section 48.4 forms a nonlinear path.

FIG. 7 shows a detailing attachment 90 with a grip 92 and a flange 94 to attach it to the rotary power tool 10.

An attachment can also be configured as a grooming attachment, a detailing attachment, a router attachment, a plunge router attachment, a mini saw attachment, a multipurpose cutting kit, a right-angle attachment, a shield rotary attachment, a sharpening kit attachment, a sanding or grinding guide attachment, a dust blower, a tile cutting attachment, a grout removal attachment etc.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected. The words used in the specification are words of description rather than limitation, and it is understood that various changes may be made without departing from the spirit and scope of the disclosure as claimed. The features of various implementing embodiments may be combined to form further embodiments of the disclosed concepts.

1. An attachment for a rotary power tool, the rotary power tool having an attachment coupler and a light source which are disposed at a front end of the rotary power tool, the attachment comprising:
a coupling portion configured to be mechanically coupled to the attachment coupler,
a proximal end configured to abut the front end,
a distal end, and
a middle portion disposed between the proximal end and the distal end,
wherein the attachment further comprises an optical waveguide that includes:
a light entrance section disposed at the proximal end and configured to be optically coupled to the light source,
a light exit section disposed at the distal end, and
an intermediate section connecting the light entrance section and the light exit section and configured to guide light from the light source to the light exit section.

2. The attachment of claim 1, wherein the coupling portion is configured to accommodate a shaft of the rotary power tool.

3. The attachment of claim 1, wherein the intermediate section forms a nonlinear path.

4. The attachment of claim 1, wherein the distal end comprises a holder for an accessory which is configured to perform an operation on a workpiece and the light exit section is arranged to emit light onto the workpiece.

5. The attachment of claim 1, wherein the distal end is configured to perform an operation on a workpiece and the light exit section is arranged to emit light onto the workpiece.

6. The attachment of claim 1, wherein the attachment comprises a flexible power transmission shaft extending from the coupling portion to the distal end and the optical waveguide is arranged along the flexible power transmission shaft.

7. The attachment of claim 1, wherein the coupling portion has an internal thread configured to be fastened to an external thread of the attachment coupler, wherein the internal thread and the external thread, when the coupling portion is mechanically coupled to the attachment coupler, define a central axis, and the internal thread and the external thread are angularly aligned to enable the light entrance section being optically coupled to the light source.

8. The attachment of claim 7, wherein the light entrance section and the light source are generally aligned in a direction that is parallel to the central axis.

9. The attachment of claim 1, wherein the attachment is a nose cap.

10. The attachment of claim 1, wherein the coupling portion is removably coupled to the attachment coupler.

11. A combination of a rotary power tool and an attachment comprising:
the rotary power tool having an attachment coupler and a light source which are disposed at a front end of the rotary power tool,
the attachment comprising:
a coupling portion mechanically coupled to the attachment coupler,
a proximal end abutting the front end,
a distal end, and
a middle portion disposed between the proximal end and the distal end, wherein the attachment further comprises an optical waveguide that includes:
a light entrance section disposed at the proximal end and optically coupled to the light source,
a light exit section disposed at the distal end, and
an intermediate section connecting the light entrance section and the light exit section and configured to guide light from the light source to the light exit section.

12. The attachment of claim 11, wherein the coupling portion accommodates a shaft of the rotary power tool.

13. The attachment of claim 12, wherein the shaft protrudes from the coupling portion.

14. The attachment of claim 11, wherein the distal end comprises a holder for an accessory which is configured to perform an operation on a workpiece and the light exit section is arranged to emit light onto the workpiece.

15. The attachment of claim 11, wherein the distal end is configured to perform an operation on a workpiece and the light exit section is arranged to emit light onto the workpiece.

16. The attachment of claim 11, wherein the attachment comprises a flexible power transmission shaft extending from the coupling portion to the distal end and the optical waveguide is arranged along the flexible power transmission shaft.

17. The attachment of claim 11, wherein the coupling portion has an internal thread that is fastened to an external thread of the attachment coupler, wherein the internal thread and the external thread define a central axis, and the internal thread and the external thread are angularly aligned so that the light entrance section is optically coupled to the light source.

18. The attachment of claim 17, wherein the light entrance section and the light source are generally aligned in a direction that is parallel to the central axis.

19. The attachment of claim 11, wherein the attachment is a nose cap.

20. The attachment of claim 11, wherein the coupling portion is removably coupled to the attachment coupler.
